(19) United States
(12) Patent Application Publication
(10) Pub. No.: US 2026/0072132 A1
(43) Pub. Date: Mar. 12, 2026

(54) MONITORING A RADIO FREQUENCY TRANSMITTER

(71) Applicant: Infineon Technologies AG, Neubiberg (DE)

(72) Inventors: Alexander BELITZER, München (DE); Andreas Sebastian OCH, Linz (AT); Tobias BUCKEL, Bad Aibling (DE); Gunther KRAUT, Egmating (DE)

(21) Appl. No.: 19/306,290

(22) Filed: Aug. 21, 2025

(30) Foreign Application Priority Data
Sep. 9, 2024 (DE) 102024208532.4

(51) Int. Cl. G01S 7/40

(52) U.S. Cl. CPC G01S 7/4008

(57) ABSTRACT

A radio frequency (RF) transmitter arrangement includes a phase shifter configured to generate an RF transmit signal based on applying one of a plurality of phase offsets to an RF reference signal. The RF transmit signal is coupled to a transmit antenna, whilst a portion of the RF transmit signal is coupled out to generate an RF feedback signal. A binary phase stepper is provided to generate an RF test signal by applying exclusively either a first phase offset or second phase offset to the RF reference signal. A mixer is provided to mix the RF test signal and RF feedback signal to generate a mixer output signal. An efficient means for monitoring the phase shifter is disclosed, which requires only two settings of the binary phase stepper.

### CROSS REFERENCE TO RELATED APPLICATION

This application claims priority to Germany Patent Application No. 102024208532.4 filed on Sep. 9, 2024, the content of which is incorporated by reference herein in its entirety.

### TECHNICAL FIELD

This implementation relates in general to radio frequency (RF) transmitters. In particular, it relates to RF transmitter arrangements and methods for assessing performance of an RF transmitter arrangement.

### BACKGROUND

Modern radar devices such as radar range and velocity sensors can be integrated in so-called monolithic microwave integrated circuits (MMIC). Radar sensors may be used, for example, in the automotive sector where they are used in advanced driver assistance systems (ADAS) such as adaptive cruise control (ACC). Such systems may be used to automatically adjust the speed of an automobile so as to maintain a safe distance from other automobiles travelling ahead. Nevertheless, RF circuits are also used in many other fields, such as RF communication systems.

A radar MMIC typically incorporates elements of the RF frontend of a radar transceiver (e.g., local oscillators, power amplifiers, low-noise amplifiers, mixers, etc.), the analog pre-processing of the intermediate frequency (IF) or base band signals (e.g., filters, amplifiers, etc.), and the analog-to-digital conversion (ADC). The RF frontend usually includes multiple reception and transmission channels in applications in which beam steering techniques and phased antenna arrays are employed (to sense the incidence angle of incoming RF radar signals).

The phase of the transmit signal must be controlled very accurately. Accordingly, the phase shift and/or amplitude gain caused by each output channel needs to be known. Therefore, feedback hardware for measuring the transmit phase is implemented in many state of the art radar MMIC transceivers. This hardware facilitates phase calibration of each transmit channel. However, this hardware requires additional space and consumes additional power.

There is therefore a desire for a compact and energy efficient means for monitoring the operation of an RF transmitter.

### SUMMARY

Examples disclosed herein propose a radio frequency (RF) transmitter arrangement, including a phase shifter, a coupler, a binary phase stepper, and a mixer. The phase shifter is configured to receive an RF reference signal and configured to generate an RF transmit signal based on applying one of a plurality of phase offsets to the RF reference signal. The coupler is configured to couple the RF transmit signal to a transmit antenna, and to couple out a portion of the RF transmit signal to generate an RF feedback signal. The binary phase stepper is configured to receive the RF reference signal, and to generate an RF test signal. The phase stepper is configured to be operable in a first mode in which the phase stepper generates the RF test signal based on applying a first phase offset to the RF reference signal and in a second mode in which the phase stepper generates the RF test signal based on applying a second phase offset to the RF reference signal, the first phase offset different to the second phase offset. The mixer is configured to receive the RF test signal and the RF feedback signal, and to mix the RF test signal and RF feedback signal to generate a mixer output signal.

Proposed approaches make use of a binary phase stepper capable of applying only two different phase offsets to the RF reference signal to generate RF test signals for comparison with the RF feedback signal to assess the transmit path of the RF transmitter arrangement (e.g., to monitor the phase shifter). In this way, the operation of the phase shifter can be assessed whilst minimising space required by the monitoring hardware, and at the same time facilitating fast monitoring. Thus, the proposed RF transmitter arrangement finds particular use when employed within radar MMIC.

Other examples disclosed herein provide a method for assessing performance of an RF transmitter arrangement. The RF transmitter arrangement includes a phase shifter configured to receive an RF reference signal and configured to generate an RF transmit signal based on applying one of a plurality of phase offsets to the RF reference signal; a coupler configured to couple the RF transmit signal to a transmit antenna, and to couple out a portion of the RF transmit signal to generate an RF feedback signal; a phase stepper configured to receive the RF reference signal, and to generate an RF test signal based on applying one or a plurality of test phase offsets to the RF reference signal; and a mixer configured to receive the RF test signal and the RF feedback signal, and to mix the RF test signal and RF feedback signal to generate a mixer output signal. The method includes:
controlling, whilst the phase stepper applies a first phase offset to the RF reference signal, the phase shifter to generate a first sequence of RF transmit signals, each of the RF transmit signals based on applying each of a test set of phase offsets to the RF reference signal; controlling, whilst the phase stepper applies a second phase offset to the RF reference signal, the phase shifter to generate a second sequence of RF transmit signals, each of the RF transmit signals based on applying each of a test set of phase offsets to the RF reference signal;
sampling the mixer output at a plurality of sampling times in order to provide a sequence of digital sample values, wherein each of the sequence of digital sample values corresponds to a respective one of the first sequence of RF transmit signals or one of the second sequence of RF transmit signals;
applying a discrete Fourier transform (DFT) to the sequence of digital sample values to generate a plurality of DFT bin values, each DFT bin value corresponding to different harmonics present in sequence of digital sample values, wherein the DFT bin values include a direct current (DC) amplitude value of the sequence of sample values, a first harmonic amplitude value of the sequence of sample values, and a third harmonic amplitude value of the sequence of sample values; and
identifying a defect of the phase shifter based on at least one of the identified DC amplitude value, first harmonic amplitude value and the third harmonic amplitude value.

The proposed method thus facilitates the detection of a defect of the phase shifter by operating a phase stepper to apply only two different phase offsets. This is achieved by operating the phase shifter to generate a sequence of RF transmit signals (by applying a test set of phase offsets to the RF reference signal) whilst the phase shifter applies a first phase offset, and whilst the phase shifter applies a second phase offset, to generate a sequence of digital sample values. Processing of these digital sample values may thus provide information for detection/identification of a defect of the phase shifter, whilst minimising power consumption and time required for completing the process.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 illustrates an RF transmitter arrangement.

FIG. 2 illustrates a binary phase stepper according to an aspect of an implementation.

FIG. 3 is a flow diagram of a method for assessing performance of an RF transmitter arrangement.

### DETAILED DESCRIPTION

Some examples described herein provide an RF transmitter arrangement. The RF transmitter arrangement comprises a binary phase stepper capable of being operated in only two modes, each mode applying a different phase offset to an RF reference signal to generate RF test signals, whilst a phase shifter generates an RF transmit signal by applying a phase offset to the RF reference signal. An RF feedback signal is taken from the RF transmit signal and compared to the RF test signals, from which operation of the phase shifter may be assessed.

Further examples described herein provide and a method for assessing performance of an RF transmitter arrangement. The method generates a sequence of digital sample values by mixing of a plurality of RF transmit signals generated by the phase shifter with RF test signals generated by the phase stepper operating in two different modes.

Proposed implementations provide a radio frequency (RF) transmitter arrangement and a method for monitoring the RF transmitter. The RF transmitter arrangement comprises a phase shifter configured to generate an RF transmit signal based on applying one of a plurality of phase offsets to an RF reference signal. The RF transmit signal is coupled to a transmit antenna, whilst a portion of the RF transmit signal is coupled out to generate an RF feedback signal. A binary phase stepper is provided to generate an RF test signal by applying exclusively either a first phase offset or second phase to the RF reference signal. A mixer is also provided to mix the RF test signal and RF feedback signal to generate a mixer output signal. As a result of the simplified hardware of the binary phase stepper (only operable in two modes), space may be saved. At the same time, an efficient means for monitoring the phase shifter is disclosed, which requires only two settings of the phase stepper.

To best understand the present disclosure, it is important to understand the operation of function of existing RF transmitter arrangements having a means for assessing performance of the phase shifter.

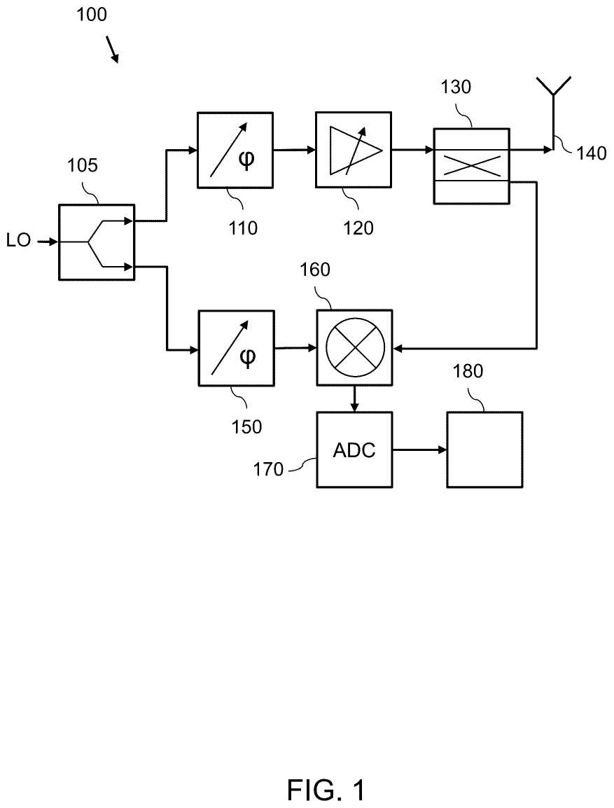

FIG. 1 illustrates an example of an RF transmitter arrangement 100. It is noted that the RF transmitter arrangement 100 of FIG. 1 is a simplified block diagram illustrating the basic structure of the RF transmitter transmit path (e.g., RF front end) and measurement path, and therefore may include additional components depending on application, for example multiple transmit paths, each applying a different phase offset to generate different RF transmit signals.

The transmit path of the RF transmitter arrangement 100 comprises a phase shifter 110, an output amplifier 120, a coupler 130, and a transmit antenna 140. The measurement path comprises a phase stepper 150, a mixer 160, an ADC converter 170, and a processor/controller 180.

An RF reference signal is generated by, for example, a local oscillator (LO). The RF reference signal may therefore also be referred to as a LO signal. The RF reference signal may be frequency modulated. In radar applications, such as in automative applications, the LO/RF reference signal is usually in the super high frequency (SHF) or the extremely high frequency (EHF) band (e.g., between 76 GHz and 81 GHZ).

The RF reference signal is fed into both the transmit path and the measurement path of the RF transmitter arrangement 100 by a splitter 105.

In the transmit path, the phase shifter 110 receives the RF reference signal, and generates an RF transmit signal. The RF transmit signal is generated by applying one of a plurality of phase offsets to the RF reference signal. Accordingly, the phase shifter 110 controls the phase of the RF transmit signal. That is, the phase shifter 110 is required for precise control of the phase of the RF transmit signal-either to program a different starting phase of the RF transmit signal or to continuously modulate the phase of the RF transmit signal. The phase shifter 110 thus controls an overall phase offset/lag of the transmit path.

In some cases, the phase shifter 110 may apply any phase offset between 0 and 360 degrees. Typically, the phase shifter 110 may the phase of the RF reference signal to one of 64 or more different (equidistant) phases. The phase shifter 110 may be implemented using IQ modulators (In-Phase/Quadrature modulators). Nevertheless, the phase shifter 110 may be any component capable of applying one of a plurality of phase offsets, as would be appreciated by the skilled person.

The transmit path may additionally include an output amplifier 120 for amplification of the RF transmit signal. The transmit path further comprises a coupler 130 configured to couple the RF transmit signal to a transmit antenna 140 for radiation into the environment.

More specifically, the coupler 130 is configured to provide power of the RF transmit signal to the transmit antenna 140, with minimal power loss. The coupler 130, also coupler a fraction of the RF transmit signal power out, and provides this to the measurement path, and more specifically to the mixer 160. This fraction is usually in the range of 20 dB to avoid that the RF signal sent to the antenna suffers from too much power reduction due to that power splitting.

It is desirable to know the precise phase offset of the RF transmit signal relative to the RF reference signal applied by the RF transmit path (e.g., actively applied by the phase shifter 110, and passively applied by other components such as the amplifier 120). Indeed, if the RF transmitter forms part of a radar sensor device, the phase of the RF transmit signal must be known to derive the radiation angle. In other words, the phase offset of the RF transmit signal must be tuned to specific values to achieve a desired radiation angle.

However, various factors may impact the phase offset of the transmit path. For example, the temperature of the components in the transmit path may alter the phase offset applied by these components. Furthermore, production tolerances and aging may impact the phase offset applied by the components, in particular the phase shifter 110. Accordingly, any imperfections of the phase offset must be to be detected and compensated for (e.g., by calibration of the phase shifter 110) to ensure correct operation of the RF transmitter. This is pertinent for radar applications, and in particular in radar used for the automotive sector, as any errors may render the radar unsafe to use. Nonetheless, compensation of the phase offset may also be required for other applications such as, for example, in wireless communication systems.

Accordingly, it is typical for state-of-the-art RF transceivers to comprise a measurement path as depicted.

The measurement path comprises a phase stepper 150 configured to receive the RF reference signal, and to apply one of a plurality of phase offsets to the RF reference signal to generate an RF test signal. Similarly to the phase shifter 110 of the transmit path, the phase stepper 150 applies one of a plurality of (usually equidistant) phase offsets between 0 and 360 degrees.

In contrast to the phase shifter 110, the phase stepper 150 typically has fewer settings (e.g., can be controlled to apply a fewer number of different phase offsets). Nevertheless, the more settings the phase stepper 150 has, the more accurate the result measurement of the offset of the phase offset applied by the phase shifter 110 will be (due to a noise averaging effect). Therefore it is generally desirable to provide a phase stepper 150 with a high number of settings. The compromise for this is that it may take longer to perform the measurement as more readings need to be taken and more processing is required.

Furthermore, the measurement path comprises a mixer 160 that receives the RF test signal from the phase stepper 150 and an RF feedback signal that is coupled out from the RF transmit signal by coupler 130. The RF feedback signal is thus substantially the same (e.g., has the same phase offset) as the RF transmit signal.

The mixer 160 combines the RF test signal and the RF feedback signal to generate a mixer output signal. Specifically, the RF test signal is down converter with the RF feedback signal by the mixer 160, resulting in a mixer output signal.

Finally, the mixer output signal is digitized by an analog-to-digital converter (ADC). That is the mixer output signal is sampled by the ADC 170 to generate digital sample values. The digital sample values may then be processed by a processor 180 to extract the amplitude and phase information.

More specifically, in order to extract a phase measurement of the phase shifter 110 for one setting of the phase shifter 110 (e.g., for one phase offset applied by the phase shifter 110), the following procedure is performed:
(i) the phase shifter 110 is controlled to apply the phase offset to the RF reference signal to generate an RF transmit signal (and thus a particular RF feedback signal);
(ii) the phase stepper 150 is controlled to apply each of the plurality of phase offsets available from the phase stepper 150 (e.g., cycles through each phase stepper 150 setting);
(iii) for each offset applied by the phase stepper 150, (and after the signals have settled) the ADC is controlled to generate a digital sample value by sampling the mixer output signal;
(iv) once all digital sample values are generated, an FFT is applied to the digital sample values;
(v) phase and amplitude information extracted from the first harmonic of the FFT.

Accordingly, to extract phase and amplitude information of the transmit path for one phase setting of the phase shifter 110, the phase stepper 150 must be cycled through various settings, and measurements taken during each setting. It should be noted that the amplitude of the transmit path comprises the amplitude of the output amplifier 120, and the phase of the transmit path comprises the controllable phase of the phase shifter 110 and the phase of the output amplifier 120. There is also another phase shift applied in the measurement path from the output of the coupler 130, to the input of the mixer 160 (which is substantially constant, as this comprises passive elements).

It should be noted that during this measurement procedure, the transmitter has to be active and therefore consumes power. It should also be noted that, as the phase stepper 150 must have a large number of settings, the phase stepper 150 consumes a large amount of space, which is particularly disadvantageous when the RF transmitter arrangement 100 is implemented in a radar MMIC. Furthermore, the measurement procedure consumes power and therefore may heat the RF transmitter arrangement 100, leading to further deviation of the phase offset. It has therefore been realised that there is a need for an improved means for monitoring the phase offset applied by the transmit path.

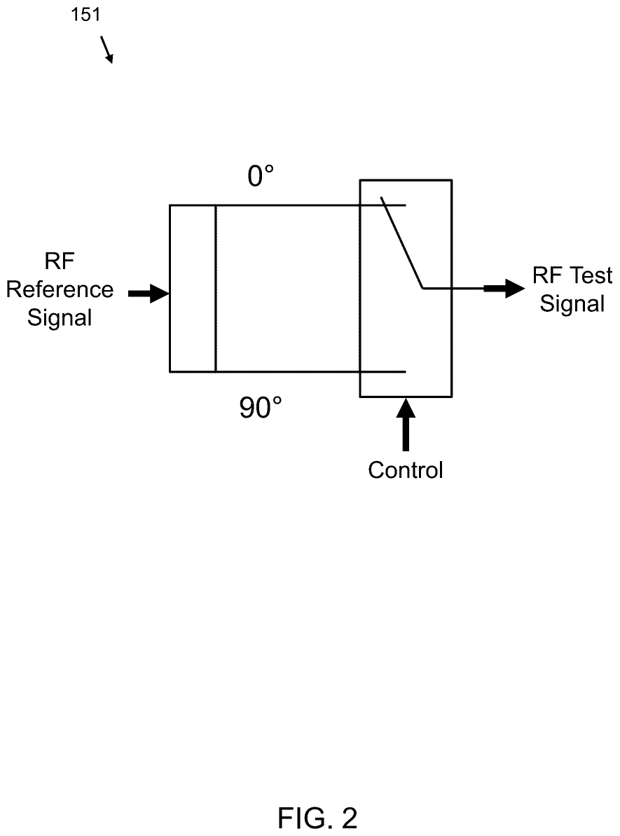

FIG. 2 illustrates a binary phase stepper 151 according to this aspect of the implementation. The depicted binary phase stepper 151 replaces the phase stepper 150 described above.

It is proposed to replace the phase stepper 150 typically used for monitoring the phase offset applied by the transmit path, with a binary phase stepper 151. That is, known phase steppers are operable in a large number of different modes/settings, to provide a high number of different phase offsets. Indeed, this is often desired in order to improve accuracy of measurement using the known measurement technique described above (in which a sample is taken of the mixer output signal for each RF test signal as the phase stepper cycles through each of a plurality of phase offsets). In contrast, the proposed solution provides a binary phase stepper 151 that is exclusively operable in only two modes.

As can be seen, the binary phase stepper 151 is only operable in a first mode in which the phase stepper 151 generates the RF test signal based on applying a first phase offset (e.g., 0 degrees) to the RF reference signal and in a second mode in which the phase stepper 151 generates the RF test signal based on applying a second phase offset (e.g., 90 degrees) to the RF reference signal. To be clear, the first phase offset is different to the second phase offset.

This significantly reduces the area and complexity of the phase stepper 150, as only two different offsets need to be applied by the binary phase stepper 151.

In one implementation, a difference between the first phase offset and the second phase offset of the binary phase stepper 151 is 90 degrees. For example, the first phase offset may be 0 degrees, and the second phase offset may be 90 degrees. As will be clear from the below, this selection of phase offsets may simplify processing/calculations for determining phase and amplitude information of the RF transmit signal. Nevertheless, alternative phase offsets may still enable the derivation of phase and amplitude information.

Accordingly, in order to determine phase information of the RF transmit signal, the controller 180 of the RF transmitter arrangement 100 may be configured to first control, whilst the binary phase stepper 151 operates in the first mode (e.g., whilst the binary phase stepper 151 applies the first phase offset to the RF reference signal to generate the RF test signal), the phase shifter 110 to generate a first sequence of RF transmit signals. Each of the RF transmit signals in this case are based on applying each of a test set of phase offsets to the RF reference signal. The controller 180 also controls the ADC to sample the mixer output at a first plurality of sampling times in order to provide a first sequence of digital sample values, wherein each of the first sequence of digital sample values corresponds to a respective one of the first sequence of RF transmit signals.

Essentially, in order to determine phase and amplitude information of the transmit path for one setting of the phase shifter 110 (e.g., for the application of an X degree offset by the phase shifter 110), the phase stepper 151 is controlled to apply only one phase offset to the RF reference signal in order to generate the RF test signal. In order to gather sufficient information to determine the phase and amplitude information, the phase shifter 110 is controlled to cycle through a plurality of test phase offsets.

That is, rather than cycling the phase stepper 150 through a large number of settings (which requires a phase stepper 150 capable of applying a large number of phase offsets), the phase shifter 110 is controlled to cycle through a number of settings. For example, the phase shifter 110 may be controlled to apply a test phase offset in addition to the phase offset setting that is being assessed (e.g., X degrees), with a first test phase offset (e.g., 0 degrees), a second test phase offset (e.g., 90 degrees), a third test phase offset (e.g., 180 degrees), and a fourth test phase offset (e.g., 270 degrees) applied. Of course, the ADC may be controlled to generate digital sample values, each digital sample value corresponding to a mixer output when the phase shifter 110 is controlled to apply each of these test phase offsets.

The above examples should not be considered restrictive, and alternative test phase offsets may be applied. Nevertheless, it may simplify subsequent processing/calculations by having a set of equidistant phase offsets, such as 0, 90, 180 and 270 degrees.

Put another way, rather than the procedure for extracting a phase measurement of the phase shifter 110 described above, the following procedure is proposed for calculating phase and amplitude information for one setting of the phase shifter 110:
(i) the phase stepper is controlled by the switch to operate in a first mode in which a first phase offset is applied (e.g., 0 degree phase offset, or 90 degree phase offset) to the RF reference signal to generate the RF test signal;
(ii) the phase shifter 110 is controlled to apply one of the plurality of test phase offsets to the RF reference signal to generate an RF transmit signal (and thus a particular RF feedback signal). The test phase offsets may comprise equidistant phase offsets. For example, the test phase offsets may comprise four equidistant phase offsets (e.g., X+0, 90, 180 and 270 degrees);
(iii) for each test phase offset applied by the phase shifter 110, (and after the signals have settled) the ADC is controlled to generate a digital sample value by sampling the mixer output signal;
(iv) once all digital sample values are generated, an FFT is applied to the digital sample values. For example, when four equidistant phase offsets are applied by the phase shifter 110, a simple 4-point FFT can be applied requiring only basic arithmetic operations applied to the four digital sample values;
(v) phase and amplitude information extracted from the first harmonic of the FFT.

Thus, it has been realised that it is only necessary to provide a phase stepper 151 having two modes of operation (e.g., capable of applying only two phase offsets to the RF reference signal). This greatly decreases complexity of the phase stepper 151, saving silicon space and reducing power consumption.

In one example, the phase stepper 151 is configured to apply a 0 degree phase offset to the RF reference signal, and the phase shifter 110 is configured to apply 0, 90, 180 and 270 degree test phase offsets in addition to the setting X degree of the phase shifter 110 being assessed. In this case, four digital sample values will be produced. Sig1 denotes the digital signal value associated with the phase shifter 110 applying a 0 degree test phase offset, Sig2 denotes the digital signal value associated with the phase shifter 110 applying a 90 degree test phase offset, Sig3 denotes the digital signal value associated with the phase shifter 110 applying a 180 degree test phase offset, and Sig4 denotes the digital signal value associated with the phase shifter 110 applying a 270 degree test phase offset.

In this case, a very simple four point FFT may be calculated according to the following:

$$Re 1 = Sig 1 - Sig 3 \qquad [ 1 ]$$

$$Im 1 = - ( Sig 2 - Sig 4 ) \qquad [ 2 ]$$

Thus, by simple arithmetic functions applied to the voltages represented by the digital sample values, the phase and amplitude information may then be extracted in a straightforward manner from the Rel+j*Iml signal.

Of course, this is one simplified example of how this procedure may be performed. Alternative test phase offsets may be applied, from which phase and amplitude information may be derived. Nevertheless, the above example provides for a highly simple, and therefore fast and energy efficient, means for measuring the phase and amplitude information of the transmit path, corresponding to the phase shifter 110 operating according to a given setting.

The RF transmitter arrangement 100 may therefore include a processor 180 configured to receive the first sequence of digital sample values and generate phase and amplitude information of the RF transmit signal based on a result of processing the first set of digital sample values with a discrete Fourier transform.

The processor 180 may then be further configured to modify an operating parameter of the phase shifter 110 and/or generate a signal indicating failure of the phase shifter 110 based on the generated phase and amplitude information. That is, if the generated phase and amplitude information do not correspond to expected values, then action may be taken to report and correct operation of the phase shifter 110.

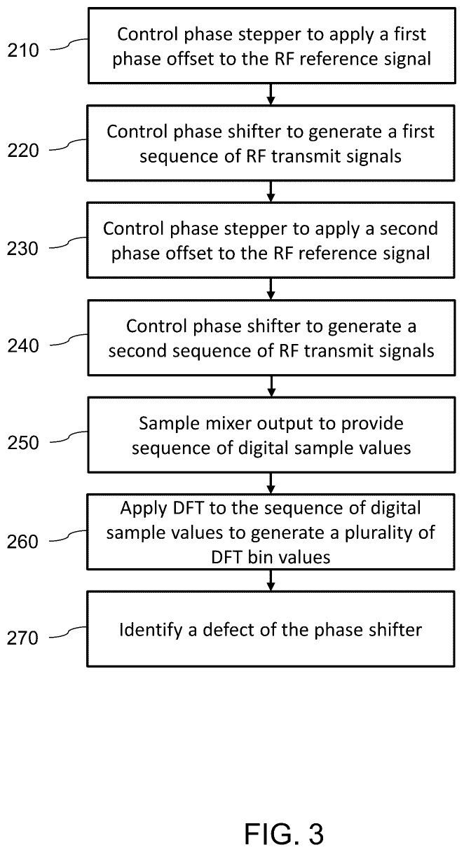

According to a further aspect of the present implementation, there is provided a method for assessing performance of an RF transmitter arrangement that is faster than existing methods. This method is depicted in FIG. 3 in the form of a flow diagram.

In a state-of-the-art implementation, the performance/function of the phase shifter of an RF transmitter arrangement is usually assessed by measuring phase and amplitude information of the transmit path (in a manner as described above) for each phase setting of the phase shifter that is to be used. However, it will be appreciated that this is very time consuming, as there may be many settings of the phase shifter to be assessed, and each measurement of the phase and amplitude information takes time.

To combat this, it has recently been proposed to skip measuring phase and amplitude information for settings of the phase shifter that are less important. That is, only phase measurements of the most important settings of the phase shifter are taken, with correct operation assumed for less important settings given correct operation of the important settings. However, this assumption may lead to errors.

Accordingly, the proposed method proposes a small extension to the measurement procedure described above to provide a fast means for assessing performance of the RF transmitter arrangement, whilst avoiding the introduction of undesirable assumptions.

To be clear, the proposed method may be performed on the RF transmitter arrangement as described above including a binary phase stepper operable in only two modes, but may equally be applied to an RF transmitter arrangement having a phase stepper operable in more than two modes (but may not require use of more than two modes of such a phase stepper).

In other words, the RF transmitter arrangement comprises a phase shifter configured to receive an RF reference signal and configured to generate an RF transmit signal based on applying one of a plurality of phase offsets to the RF reference signal. The RF transmitter also includes a coupler configured to couple the RF transmit signal to a transmit antenna, and to couple out a portion of the RF transmit signal to generate an RF feedback signal.

Furthermore, there is provided a phase stepper configured to receive the RF reference signal, and to generate an RF test signal based on applying one or a plurality of test phase offsets to the RF reference signal. In some implementations, the phase stepper is a binary phase stepper as depicted in FIG. 2. Finally, the RF transmitter arrangement comprises a mixer configured to receive the RF test signal and the RF feedback signal, and to mix the RF test signal and RF feedback signal to generate a mixer output signal.

In step 210, the phase stepper applies a first phase offset to the RF reference signal. Accordingly, the phase stepper generates an RF test signal having the first phase offset, and provides the RF test signal to the mixer. The first phase offset may be, for example, 0 degrees. Nevertheless, examples are not limited to 0 degrees.

In step 220, whilst the phase stepper applies the first phase offset to the RF reference signal, the phase shifter is controlled to generate a first sequence of RF transmit signals. Each of the RF transmit signals are based on applying each of a test set of phase offsets to the RF reference signal. In this way, a sequence of RF feedback signals is generated and provided to the mixer, whilst the RF test signal with the first phase offset is also provided to the mixer.

In step 230, the phase stepper applies a second phase offset to the RF reference signal. Accordingly, the phase stepper generates an RF test signal having the second phase offset, and provides the RF test signal to the mixer. The second phase offset may be, for example, 90 degrees. Nevertheless, examples are not limited to 90 degrees, as long as the second phase offset is different to the first phase offset.

In step 240, whilst the phase stepper applies the second phase offset to the RF reference signal, the phase shifter is controlled to generate a second sequence of RF transmit signals. Each of the RF transmit signals are based on applying each of the test set of phase offsets to the RF reference signal. In this way, a sequence of RF feedback signals is generated and provided to the mixer, whilst the RF test signal with the second phase offset is also provided to the mixer.

The test set of phase offsets may comprise equidistant phase offsets. For example, the test set of phase offsets may comprise four equidistant phase offsets, such as 0, 90, 180 and 270 degrees.

It should be noted that steps 210-240 may be performed in different orders. For example, the phase shifter may be set to apply one of the test set of phase offsets whilst the phase stepper is controlled to sequentially apply the first and second phase offset. In any case, the phase stepper and phase shifter must be controlled such that the mixer receives a full combination of the RF feedback signals having the test phase offsets, and the RF test signal having the first and second phase offsets.

In step 250, the mixer output is sampled at a plurality of sampling times in order to provide a sequence of digital sample values. That is, the mixer combines the input RF test signal and RF feedback signal, and the resultant output is sampled at a number of different times. Each of the sequence of digital sample values corresponds to a respective one of the first sequence of RF transmit signals or one of the second sequence of RF transmit signals. That is, the output of the mixer is sampled for each combination of the first or second sequence of RF transmit signals from the phase shifter, and the test signals from the phase stepper. Accordingly, a sequence of digital sample values is obtained for the full combination of the two settings of the phase stepper and the test settings of the phase shifter.

To be clear, the digital sample values will each correspond to a downconverter signal with an amplitude dependent on the phase difference between the RF feedback signal and RF test signal at the time that the sample is taken from the mixer. This sampling may be performed, for example, by an ADC.

In step 260, a discrete Fourier transform is applied to the sequence of digital sample values to generate a plurality of DFT bin values. Each DFT bin value corresponds to different harmonics present in sequence of digital sample values. The DFT bin values include at least a DC amplitude value of the sequence of sample values (e.g., a zeroth order harmonic amplitude value), a first harmonic amplitude value of the sequence of sample values, and a third harmonic amplitude value of the sequence of sample values.

In step 270, a defect of the phase shifter is identified based on at least one of the identified DC amplitude value, first harmonic amplitude value and the third harmonic amplitude value.

For example, if the magnitude of the first harmonic amplitude value is much greater than that of the DC amplitude value and the third harmonic amplitude value, this would indicate that the phase shifter is operating normally. If this is not the case, then the relative proportions between the magnitude of the DC, first harmonic, and third harmonic amplitude values indicate failure, and may also indicate the type and/or source of failure.

That is, if the phase shifter is functioning incorrectly, the DC and third harmonic components may become large and/or the first harmonic component may become unacceptably small. Thus, these values may be compared to a variety of pass/fail conditions to identify a fault. More particularly, if the first harmonic amplitude value fails to meet a first harmonic condition, the DC amplitude value meets a DC failure condition, and/or the third harmonic amplitude value meets a third harmonic (e.g., image) failure condition, then a fault may be identified.

Nevertheless, implementations are not restricted hereto, and a combination of the DFT bin values may be processed in order to identify a fault (e.g., a summation of the DC amplitude value and the third harmonic amplitude value, etc.). The conditions by which failure or success is assessed may depend on the particular application.

Although not depicted, the method may then comprise further steps of modification of the operation of the phase shifter based on the identified defect. Thus, the method may provide a means for automatic correction/calibration of a phase shifter. Additionally or alternatively, an output signal may be generated indicating failure of the phase shifter based on the identified defect of the phase shifter.

It will be noted that the above method may be performed by the controller/processor described in relation to FIG. 1.

By way of specific example, the first phase offset is a 0 degree phase offset (e.g., the phase stepper applies a 0 degree offset to the RF reference signal) and the second phase offset is a 90 degree phase offset (e.g., the phase stepper applies a 90 degree offset to the RF reference signal). The test set of phase offsets applied to the RF reference signal by the phase shifter includes 0, 90, 180 and 270 degree phase offsets. Essentially, the process performs the measurement procedure described above, but in conditions in which the phase stepper applies a 0 degree phase offset as well as a 90 degree phase offset.

More specifically, four digital sample values will be produced for each setting of the phase stepper, and therefore eight digital sample values in total. Sin1 . . . 4 denotes the digital signal values associated with the phase stepper applying a 90 degree test phase offset, whilst the phase shifter applies each of the phase offsets of the test set (e.g., Sin2 denotes the digital sample value generated when the phase stepper applies the 90 degree phase offset and the phase shifter applies the 90 degree phase offset). Cos1 . . . 4 denotes the digital signal values associated with the phase stepper applying a Odegree test phase offset, whilst the phase shifter applies each of the phase offsets of the test set (e.g., Cos3 denotes the digital sample value generated when the phase stepper applies the Odegree phase offset and the phase shifter applies the 180 degree phase offset).

In this case, applying the DFT to generate the DFT bin values comprises a calculation of a four-point-complex-FFT. Due to the selection of the phase stepper settings and the test set of phase offsets chosen in this example, only sum-operands are required, meaning that the process of applying the Fourier transform is computationally efficient and fast.

In particular, the DC component may be calculated by:

$$Re 0 = cos 1 + cos 2 + cos 3 + cos 4 \qquad [ 3 ]$$

$$Im 0 = sin 1 + sin 2 + sin 3 + sin 4 \qquad [ 4 ]$$

The first harmonic component can be calculated by:

$$Re 3 = cos 1 + sin 2 - cos 3 - sin 4 \qquad [ 5 ]$$

$$Im 1 = sin 1 - cos 2 - sin 3 + cos 4 \qquad [ 6 ]$$

The third harmonic component can be calculated by:

$$Re 3 = cos 1 - sin 2 - cos 3 + sin 4 \qquad [ 7 ]$$

$$Im 3 = sin 1 + cos 2 - sin 3 - cos 4 \qquad [ 8 ]$$

Thus, by simple arithmetic functions applied to the voltages represented by the digital sample values, the various harmonic components can be deduced in a straightforward manner from the cos1 . . . 4 and sin1 . . . 4 signals.

As demonstrated, the main benefit of the extended procedure is that no additional measurement is required for monitoring of the correct functionality of the phase shifter beyond repeating the measurement for two phase stepper settings. In other words, it is not necessary to cycle through each used setting of the phase shifter in order to determine correct operation of the phase shifter. In essence, the number of measurements that need to be taken to deduce the performance of the phase shifter are minimised. Therefore, minimal additional power consumption is required for monitoring.

In addition to the above described examples, the following examples are disclosed.

Example 1 is an RF transmitter arrangement comprising:
a phase shifter configured to receive an RF reference signal and configured to generate an RF transmit signal based on applying one of a plurality of phase offsets to the RF reference signal;
a coupler configured to couple the RF transmit signal to a transmit antenna, and to couple out a portion of the RF transmit signal to generate an RF feedback signal;
a binary phase stepper configured to receive the RF reference signal, and to generate an RF test signal, wherein the phase stepper is configured to be operable in a first mode in which the phase stepper generates the RF test signal based on applying a first phase offset to the RF reference signal and in a second mode in which the phase stepper generates the RF test signal based on applying a second phase offset to the RF reference signal, the first phase offset different to the second phase offset; and
a mixer configured to receive the RF test signal and the RF feedback signal, and to mix the RF test signal and RF feedback signal to generate a mixer output signal.

Example 2 is the RF transmitter arrangement of example 1 further comprising:
an analog-to-digital converter, ADC, configured to sample the mixer output signal to generate digital sample values; and
a controller configured to:
control, whilst the binary phase stepper operates in the first mode, the phase shifter to generate a first sequence of RF transmit signals, each of the RF transmit signals based on applying each of a test set of phase offsets to the RF reference signal; and
control the ADC to sample the mixer output at a first plurality of sampling times in order to provide a first sequence of digital sample values, wherein each of the first sequence of digital sample values corresponds to a respective one of the first sequence of RF transmit signals.

Example 3 is the RF transmitter arrangement of example 2, further comprising a processor configured to receive the first sequence of digital sample values and generate phase and amplitude information of the RF transmit signal based on a result of processing the first set of digital sample values with a DFT.

Example 4 is the RF transmitter arrangement of example 3, wherein the processor is further configured to modify an operating parameter of the phase shifter and/or generate a signal indicating failure of the phase shifter based on the generated phase and amplitude information.

Example 5 is the RF transmitter arrangement of any of examples 2-4, wherein the controller is further configured to:
control, whilst the binary phase stepper operates in the second mode, the phase shifter to generate a second sequence of RF transmit signals by applying each of the plurality of phase offsets; and
control the ADC to sample the mixer output at a second plurality of sampling times in order to provide a second sequence of digital sample values, wherein each of the second sequence of digital sample values corresponds to a respective one of the second sequence of RF transmit signals.

Example 6 is the RF transmitter arrangement of example 5, further comprising a processor configured to:
receive the first sequence of digital sample values and the second sequence of digital sample values;
apply a DFT to the first sequence of digital sample values and the second sequence of digital sample values to generate a plurality of DFT bin values, each DFT bin value corresponding to different harmonics present in the first sequence of digital sample values and the second sequence of digital sample values.

Example 7 is the RF transmitter arrangement of example 6, wherein the DFT bin values comprise a DC amplitude value of the sequence of sample values, a first harmonic amplitude value of the sequence of sample values, and a third harmonic amplitude value of the sequence of sample values. In this case the processor is further configured to identify a defect of the phase shifter based on at least one of the identified DC amplitude value, first harmonic amplitude value and the third harmonic amplitude value.

Example 8 is the RF transmitter arrangement of example 7, wherein the processor is further configured to generate an error signal responsive to the identified DC amplitude meeting a DC failure condition, the identified first harmonic amplitude value meeting a first harmonic condition, and/or the identified third harmonic meeting a third harmonic failure condition.

Example 9 is the RF transmitter arrangement of any of example 7 or 8, wherein the processor is further configured to modify an operating parameter of the phase shifter and/or generate a signal indicating failure of the phase shifter based on the identified defect of the phase shifter.

Example 10 is the RF transmitter arrangement of any of examples 3-9, wherein applying the DFT comprises processing the sequence of digital sample values analytically using only arithmetic and geometric functions and/or approximations.

Example 11 is RF transmitter arrangement of any of examples 1-10, wherein a difference between the first phase offset and the second phase offset of the binary phase stepper is 90 degrees.

Example 12 is the RF transmitter arrangement of any of examples 1-11, wherein the test set of phase offsets comprise equidistant phase offsets.

Example 13 is a method for assessing performance of an RF transmitter arrangement. The RF transmitter arrangement comprises a phase shifter configured to receive an RF reference signal and configured to generate an RF transmit signal based on applying one of a plurality of phase offsets to the RF reference signal; a coupler configured to couple the RF transmit signal to a transmit antenna, and to couple out a portion of the RF transmit signal to generate an RF feedback signal; a phase stepper configured to receive the RF reference signal, and to generate an RF test signal based on applying one or a plurality of test phase offsets to the RF reference signal; and a mixer configured to receive the RF test signal and the RF feedback signal, and to mix the RF test signal and RF feedback signal to generate a mixer output signal. The method comprises:
controlling, whilst the phase stepper applies a first phase offset to the RF reference signal, the phase shifter to generate a first sequence of RF transmit signals, each of the RF transmit signals based on applying each of a test set of phase offsets to the RF reference signal;
controlling, whilst the phase stepper applies a second phase offset to the RF reference signal, the phase shifter to generate a second sequence of RF transmit signals, each of the RF transmit signals based on applying each of a test set of phase offsets to the RF reference signal;
sampling the mixer output at a plurality of sampling times in order to provide a sequence of digital sample values, wherein each of the sequence of digital sample values corresponds to a respective one of the first sequence of RF transmit signals or one of the second sequence of RF transmit signals;
applying a discrete Fourier transform, DFT, to the sequence of digital sample values to generate a plurality of DFT bin values, each DFT bin value corresponding to different harmonics present in sequence of digital sample values, wherein the DFT bin values comprise a DC amplitude value of the sequence of sample values, a first harmonic amplitude value of the sequence of sample values, and a third harmonic amplitude value of the sequence of sample values; and
identifying a defect of the phase shifter based on at least one of the identified DC amplitude value, first harmonic amplitude value and the third harmonic amplitude value.

Example 14 is the method of example 13, further comprising modifying an operation of the phase shifter based on the identified defect of the phase shifter.

Example 15 is the method of example 13 or 14, further comprising generating an output signal indicating failure of the phase shifter based on the identified defect of the phase shifter.

Example 16 is the method of any of examples 13-15, further comprising generating phase and amplitude information of the RF transmit signal based on a result of processing the sequence of digital sample values with a DFT.

Example 17 is the method of any of examples 13-16, wherein the test set of phase offsets comprise equidistant phase offsets.

Example 18 is the method of any of examples 13-17, wherein the phase stepper is a binary phase stepper configured to be operable in a first mode in which the phase stepper generates the RF test signal based on applying a first phase offset to the RF reference signal and in a second mode in which the phase stepper generates the RF test signal based on applying a second phase offset to the RF reference signal. The method further comprises: controlling the phase stepper to operate in the first mode whilst the phase shifter is controlled to generate the first sequence of RF transmit signals; and controlling the phase stepper to operate in the second mode whilst the phase shifter is controlled to generate the second sequence of RF transmit signals.

Example 19 is the method of example 18, wherein a difference between the first phase offset and the second phase offset of the binary phase stepper is 90 degrees.

Although specific examples have been illustrated and described herein, it will be appreciated by those of ordinary skill in the art that a variety of alternate and/or equivalent implementations may be substituted for the specific examples shown and described without departing from the scope of the present implementation. This application is intended to cover any adaptations or variations of the specific examples discussed herein. Therefore, it is intended that this implementation be limited only by the claims and the equivalents thereof.

It should be noted that the methods and devices including its preferred implementations as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the implementation and are included within its spirit and scope. Furthermore, all examples and implementations outlined in the present document are principally intended expressly to be only for explanatory purposes to help the reader in understanding the principles of the proposed methods and systems. Furthermore, all statements herein providing principles, aspects, and implementations of the implementation, as well as specific examples thereof, are intended to encompass equivalents thereof.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The implementations may be implemented using hardware comprising several distinct elements. In a device claim enumerating several means, several of these means may be embodied by one and the same item of hardware. The mere fact that certain measures are recited in mutually different dependent claims does not indicate that a combination of these measures cannot be used. Furthermore in the appended claims lists comprising “at least one of: A; B; and C” should be interpreted as (A and/or B) and/or C.

1. A radio frequency (RF) transmitter arrangement, comprising:
a phase shifter configured to receive an RF reference signal and configured to generate an RF transmit signal based on applying one of a plurality of phase offsets to the RF reference signal;
a coupler configured to couple the RF transmit signal to a transmit antenna, and to couple out a portion of the RF transmit signal to generate an RF feedback signal;
a binary phase stepper configured to receive the RF reference signal, and to generate an RF test signal, wherein the binary phase stepper is configured to be operable in a first mode in which the binary phase stepper generates the RF test signal based on applying a first phase offset to the RF reference signal and in a second mode in which the binary phase stepper generates the RF test signal based on applying a second phase offset to the RF reference signal, the first phase offset different to the second phase offset; and
a mixer configured to receive the RF test signal and the RF feedback signal, and to mix the RF test signal and RF feedback signal to generate a mixer output signal.

2. The RF transmitter arrangement of claim 1, further comprising:
an analog-to-digital converter (ADC) configured to sample the mixer output signal to generate digital sample values; and
a controller configured to:
control, whilst the binary phase stepper operates in the first mode, the phase shifter to generate a first sequence of RF transmit signals, each RF transmit signal of the first sequence of RF transmit signals based on applying each phase offset of a test set of phase offsets to the RF reference signal; and
control the ADC to sample the mixer output signal at a first plurality of sampling times in order to provide a first sequence of digital sample values, wherein each of the first sequence of digital sample values corresponds to a respective one of the first sequence of RF transmit signals.

3. The RF transmitter arrangement of claim 2, further comprising:
a processor configured to receive the first sequence of digital sample values and generate phase and amplitude information of an RF transmit signal of the first sequence of RE transmit signals based on a result of processing the first sequence of digital sample values with a discrete Fourier transform, DET (DFT).

4. The RF transmitter arrangement of claim 3, wherein the processor is further configured to modify an operating parameter of the phase shifter and/or generate a signal indicating failure of the phase shifter based on the phase and amplitude information.

5. The RF transmitter arrangement of claim 2, wherein the controller is further configured to:
control, whilst the binary phase stepper operates in the second mode, the phase shifter to generate a second sequence of RF transmit signals by applying each of the plurality of phase offsets; and
control the ADC to sample the mixer output signal at a second plurality of sampling times in order to provide a second sequence of digital sample values, wherein each of the second sequence of digital sample values corresponds to a respective one of the second sequence of RF transmit signals.

6. The RF transmitter arrangement of claim 5, further comprising a processor configured to:
receive the first sequence of digital sample values and the second sequence of digital sample values; and
apply a discrete Fourier transform (DFT) DFT to the first sequence of digital sample values and the second sequence of digital sample values to generate a plurality of DFT bin values, each DFT bin value corresponding to different harmonics present in the first sequence of digital sample values and the second sequence of digital sample values.

7. The RF transmitter arrangement of claim 6, wherein the DFT bin values comprise a direct current (DC) amplitude value of the sequence of sample values, a first harmonic amplitude value of the sequence of sample values, and a third harmonic amplitude value of the sequence of sample values, and
wherein the processor is further configured to identify a defect of the phase shifter based on at least one of the DC amplitude value of the sequence of sample values, first harmonic amplitude value of the sequence of sample values, or the third harmonic amplitude value of the sequence of sample values.

8. The RF transmitter arrangement of claim 7, wherein the processor is further configured to generate an error signal responsive to the DC amplitude value of the sequence of sample values meeting a DC failure condition, the first harmonic amplitude value of the sequence of sample values meeting a first harmonic condition, and/or the third harmonic amplitude value of the sequence of sample values meeting a third harmonic failure condition.

9. The RF transmitter arrangement of claim 7, wherein the processor is further configured to modify an operating parameter of the phase shifter and/or generate a signal indicating failure of the phase shifter based on the identified defect of the phase shifter.

10. The RF transmitter arrangement of claim 3, wherein applying the DFT comprises processing the sequence of digital sample values analytically using only arithmetic and geometric functions and/or approximations.

11. The RF transmitter arrangement of claim 1, wherein a difference between the first phase offset and the second phase offset of the binary phase stepper is 90 degrees.

12. The RF transmitter arrangement of claim 2, wherein the test set of phase offsets comprises equidistant phase offsets.

13. A method for assessing performance of a radio frequency (RF) transmitter arrangement, the RF transmitter arrangement comprising a phase shifter configured to receive an RF reference signal and configured to generate an RF transmit signal based on applying one of a plurality of phase offsets to the RF reference signal; a coupler configured to couple the RF transmit signal to a transmit antenna, and to couple out a portion of the RF transmit signal to generate an RF feedback signal; a phase stepper configured to receive the RF reference signal, and to generate an RF test signal based on applying one or a plurality of test phase offsets to the RF reference signal; and a mixer configured to receive the RF test signal and the RF feedback signal, and to mix the RF test signal and RF feedback signal to generate a mixer output signal,
the method comprising:
controlling, whilst the phase stepper applies a first phase offset to the RF reference signal, the phase shifter to generate a first sequence of RF transmit signals, each of the RF transmit signals based on applying each phase offset of a test set of phase offsets to the RF reference signal;
controlling, whilst the phase stepper applies a second phase offset to the RF reference signal, the phase shifter to generate a second sequence of RF transmit signals, each of the RF transmit signals based on applying each phase offset of the test set of phase offsets to the RF reference signal;
sampling the mixer output signal at a plurality of sampling times in order to provide a sequence of digital sample values, wherein each of the sequence of digital sample values corresponds to a respective one of the first sequence of RF transmit signals or one of the second sequence of RF transmit signals;
applying a discrete Fourier transform (DFT) to the sequence of digital sample values to generate a plurality of DFT bin values, each DFT bin value corresponding to different harmonics present in sequence of digital sample values, wherein the DFT bin values comprise a direct current (DC) amplitude value of the sequence of sample values, a first harmonic amplitude value of the sequence of sample values, and a third harmonic amplitude value of the sequence of sample values; and
identifying a defect of the phase shifter based on at least one of the DC amplitude value of the sequence of sample values, the first harmonic amplitude value of the sequence of sample values, or the third harmonic amplitude value of the sequence of sample values.

14. The method of claim 13, further comprising modifying an operation of the phase shifter based on the identified defect of the phase shifter.

15. The method of claim 13, further comprising generating an output signal indicating failure of the phase shifter based on the identified defect of the phase shifter.

16. The method of claim 13, further comprising generating phase and amplitude information of the RF transmit signal based on a result of processing the sequence of digital sample values with a DFT.

17. The method of claim 13, wherein the test set of phase offsets comprises equidistant phase offsets.

18. The method of claim 13, wherein the phase stepper is a binary phase stepper configured to be operable in a first mode in which the binary phase stepper generates the RF test signal based on applying a first phase offset to the RF reference signal and in a second mode in which the binary phase stepper generates the RF test signal based on applying a second phase offset to the RF reference signal, and wherein the method further comprises:
controlling the binary phase stepper to operate in the first mode whilst the phase shifter is controlled to generate the first sequence of RF transmit signals; and
controlling the binary phase stepper to operate in the second mode whilst the phase shifter is controlled to generate the second sequence of RF transmit signals.

19. The method of claim 18, wherein a difference between the first phase offset and the second phase offset of the binary phase stepper is 90 degrees.
